(19) United States
(12) Patent Application Publication
(10) Pub. No.: US 2008/0202272 A1
(43) Pub. Date: Aug. 28, 2008

(54) Method of driving rough and fine movement mechanism

(76) Inventor: Naoki Kanayama, Nagano-ken (JP)

Correspondence Address: FLYNN THIEL BOUTELL & TANIS, P.C., 2026 RAMBLING ROAD, KALAMAZOO, MI, 49008-1631, US

(21) Appl. No.: 12/009,672

(22) Filed: Jan. 22, 2008

(30) Foreign Application Priority Data
Feb. 27, 2007 (JP) 2007-047695

(51) Int. Cl. G05G 11/00

(52) U.S. Cl. 74/479.01

(57) ABSTRACT

In operation of a rough and fine movement mechanism (1) of a linear drive type, a fine movement mechanism (3), on which an objective workpiece to be positioned (8) is mounted, is transferred toward a target point at a high speed by a rough movement mechanism (2) and roughly positioned around the target point. Subsequently, the objective workpiece (8) is transferred in a narrow stroke range by the fine movement mechanism (3) and accurately positioned at the target point. The objective workpiece (8) is transferred with a high acceleration by the rough movement mechanism (2) under a condition where the fine movement mechanism (3) is mechanically connected to the rough movement mechanism (2) by a braking mechanism 9. As a result, when the rough movement mechanism (2) is accelerated, no load acts on the fine movement mechanism (3) or such a load can be decreased. Consequently, a rough and fine movement mechanism, which enables both high-speed positioning by the rough movement mechanism and high-accuracy positioning by the fine movement mechanism consistently, can be realized.

### FIELD OF THE INVENTION

The present invention relates to a rough and fine movement mechanism structured with a combination of a plurality of actuators having different characteristics, and particularly to a method of driving the rough and fine movement mechanism wherein a rough movement mechanism is moved at a high speed being free from any restriction owing to a holding thrust or a holding torque of a fine movement mechanism.

### BACKGROUND ART

Generally, a high-accuracy positioning mechanism, which can carry out high-accuracy positioning in a wide range of movement, is expensive. Used for such an operation purpose, therefore, is a rough and fine movement mechanism having a structure with a combination of a rough movement mechanism and a fine movement mechanism that are produced to be inexpensive comparatively. The rough movement mechanism can drive at a high speed and a high thrust (or, at a high torque in the case of a rotating mechanism) but with a low-accuracy positioning performance. On the other hand, the fine movement mechanism is generally provided with a high-accuracy positioning performance but at a low thrust. In operation of the rough and fine movement mechanism with a structure of a combination of the rough and fine movement mechanisms described above, an objective workpiece is transferred at a high speed toward a target point by the rough movement mechanism. Thereafter, the workpiece is moved toward the target point by the fine movement mechanism so as to be positioned at the target point accurately. Thus, using the rough and fine movement mechanism structured with a combination of a plurality of actuators having different characteristics enables the workpiece to be positioned at the target point accurately in a short time.

In the rough and fine movement mechanism, usually the fine movement mechanism is mounted on the rough movement mechanism, an objective workpiece to be positioned is mounted on the fine movement mechanism, and an operation of positioning the workpiece at the target point is carried out. Therefore, when the rough movement mechanism carries out positioning operation for the workpiece at a high speed, an inertia load of the workpiece generated by the acceleration transfer acts on the fine movement mechanism on which the workpiece is mounted. Accordingly, even though the rough movement mechanism has a capability of driving at a high speed and a high thrust, at the time of its operation the rough movement mechanism cannot practically actualize any driving force greater than a holding thrust of the fine movement mechanism. As a result, the conventional rough and fine movement mechanism has a problem that the high-speed driving performance of the rough movement mechanism cannot be utilized sufficiently.

For example, in a rough and fine movement mechanism 100 of a linear drive type shown in FIG. 2, a fine movement rail 103 is fixed on a rough movement slider 102 that slides along a rough movement rail 101, and then a fine movement slider 104 slides along the fine movement rail 103. While a workpiece 105 being mounted on the fine movement slider 104, the rough movement slider 102 carries out a rough workpiece positioning operation in a wide stroke range and the fine movement slider 104 carries out a precise workpiece positioning operation in a narrow stroke range.

Then, an inertia load, which acts on the fine movement slider 104 and the workpiece mounted on it due to the transfer of the rough movement slider 102, becomes a load onto the fine movement mechanism. Therefore, acceleration to be actualized by the rough movement mechanism is restricted according to a holding thrust of the fine movement mechanism.

### DISCLOSURE OF THE INVENTION

It is an object of the present invention to provide a method of driving a rough and fine movement mechanism that enables a rough movement mechanism to drive at a high speed being free from any restriction owing to a holding thrust (a holding torque) of a fine movement mechanism.

To solve the above and other problems, a method of driving a rough and fine movement mechanism according to the present invention includes steps of:

a first step of operating a rough movement mechanism to transfer a fine movement mechanism to a target point with a first positioning accuracy in a condition that a workpiece to be positioned is mounted on the fine movement mechanism; and

a second step of operating the fine movement mechanism to position the workpiece at the target point with a second positioning accuracy, the second positioning accuracy being higher than the first positioning accuracy; wherein

the rough movement mechanism is moved in the first step under a condition where the fine movement mechanism is mechanically connected to the rough movement mechanism, whereby the rough movement mechanism bears at least a part of a load acting on the fine movement mechanism.

A rough and fine movement mechanism for positioning a workpiece by the driving method described above includes:

a rough movement slider that slides along a rough movement rail for positioning operation in a first stroke range with the first positioning accuracy;

a fine movement slider that slides along a fine movement rail, fixed to the rough movement slider, for positioning operation in a second stroke range narrower than the first stroke range with the second positioning accuracy;

and a switching mechanism for switching between a connected condition, where the fine movement slider is mechanically connected to the rough movement slider, and an unconnected condition, where the fine movement slider is released from the rough movement slider.

The switching mechanism may include a braking mechanism for keeping the fine movement slider connected to the rough movement slider with a predefined braking force so as to prevent the fine movement slider from relatively moving in relationship with the rough movement slider.

According to the present invention; the rough movement mechanism drives at a high speed and a high thrust while the fine movement mechanism is mechanically connected to the rough movement mechanism. Therefore, an inertia load of the workpiece acting on the fine movement mechanism, which the rough movement mechanism transfers with a high acceleration when it drives at a high speed and a high thrust, is borne by the mechanism having a higher holding thrust. Thus, this arrangement allows the high-speed drive of the rough movement mechanism to be free from any restriction owing to a low holding thrust of the fine movement mechanism, or decreases such restriction described above.

Consequently, the present invention can realize a rough and fine movement mechanism that enables both high-speed positioning by the rough movement mechanism and high-accuracy positioning by the fine movement mechanism consistently.

### BRIEF DESCRIPTION OF THE DRAWINGS

FIG. 1 is a schematic view showing an embodiment of a rough and fine movement mechanism of a linear drive type to which the present invention is applied.

FIG. 2 is a schematic view showing an example of a conventional rough and fine movement mechanism of a linear drive type.

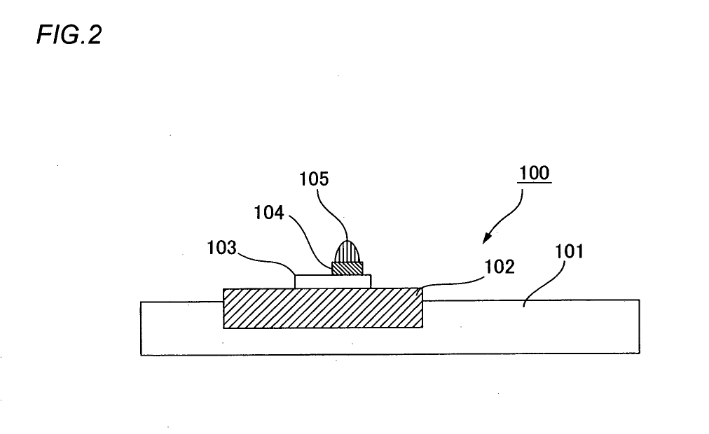

### BEST MODE FOR CARRYING OUT THE INVENTION

Described below with reference to the accompanying drawings is an embodiment of a rough and fine movement mechanism to which the present invention is adopted.

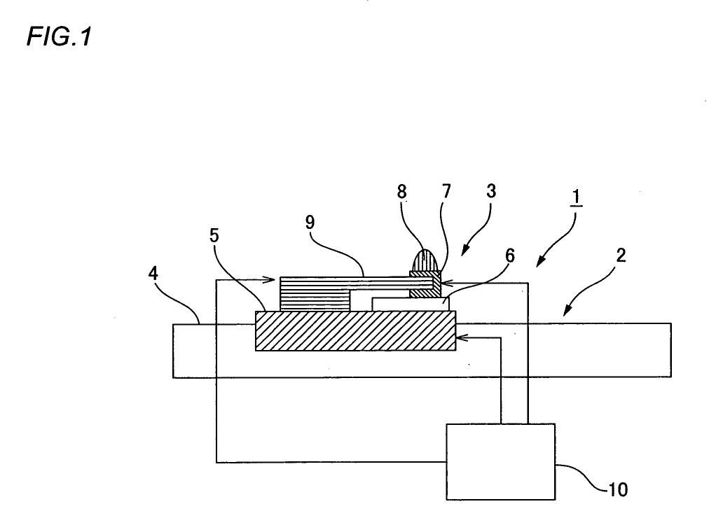

FIG. 1 is a schematic view of a rough and fine movement mechanism of a linear drive type equipped with a brake unit according to the present invention. A rough and fine movement mechanism 1 equipped with a brake unit includes a rough movement mechanism 2 and a fine movement mechanism 3. The rough movement mechanism 2 has a rough movement rail 4 and a rough movement slider 5 that slides along the rough movement rail 4. The fine movement mechanism 3 has a fine movement rail 6 fixed on the rough movement slider 5, and a fine movement slider 7 that slides along the fine movement rail 6. An objective workpiece to be positioned 8 is mounted on the fine movement slider 7.

Being compared with the fine movement slider 7, the rough movement slider 5 slides at a higher speed and a higher thrust in a wider sliding range but with a lower positioning accuracy. The fine movement slider 7 slides at a lower thrust in a narrower sliding range but with a higher positioning accuracy.

The rough movement slider 5 is equipped with a braking mechanism 9 for mechanically connecting the fine movement slider 7 to the rough movement slider 5. A control panel 10 controls operations of the rough movement slider 5, the fine movement slider 7, and the braking mechanism 9. When the rough movement slider 5 slides, the control panel 10 operates the braking mechanism 9 to connect and fix the fine movement slider 7 to the rough movement slider 5 with a predetermined braking force in order to hold the fine movement slider 7 and prevent it from relatively moving in relationship with the rough movement slider 5. When the fine movement slider 7 slides, the control panel 10 releases the braking force and cancels the connection between the rough movement slider 5 and the fine movement slider 7.

In operation of the rough and fine movement mechanism 1 having the structure as described above, the workpiece mounted on the fine movement slider 7 is roughly positioned around a target point by sliding the rough movement slider 5 at a high speed within a wide stroke range. Subsequently, by sliding the fine movement slider 7 at a predetermined speed within a narrow stroke range, the workpiece mounted on the fine movement slider 7 is accurately positioned at the target point. During the rough positioning operation in which only the rough movement mechanism 2 works, the braking mechanism 9 is operated to make the fine movement slider 7 mechanically connected and fixed to the rough movement slider 5. As a result, the inertia force acting on the fine movement slider 7 according to acceleration of the rough movement mechanism 2 does not act on the fine movement mechanism 3 but on the rough movement mechanism 2. Therefore, the rough movement mechanism 2 can carry out a high-acceleration positioning operation, being free from any restriction owing to the performance capability of the fine movement mechanism 3.

Although the present invention was described above with reference to a rough and fine mechanism of a linear drive type, it is needless to say that the present invention can also be applied in a similar way to a rough and fine movement mechanism of a rotary drive type, such as an indexing table and so on.

1. A method of driving a rough and fine movement mechanism comprising steps of:
a first step of operating a rough movement mechanism to transfer a fine movement mechanism to a target point with a first positioning accuracy in a condition that a workpiece to be positioned is mounted on the fine movement mechanism; and
a second step of operating the fine movement mechanism to position the workpiece at the target point with a second positioning accuracy, the second positioning accuracy being higher than the first positioning accuracy; wherein
the rough movement mechanism is moved in the first step under a condition where the fine movement mechanism is mechanically connected to the rough movement mechanism, whereby the rough movement mechanism bears at least a part of a load acting on the fine movement mechanism.

2. A rough and fine movement mechanism for positioning a workpiece at a target position according to a method of claim 1 comprising:
a rough movement slider that slides along a rough movement rail for positioning operation in a first stroke range with the first positioning accuracy;
a fine movement slider that slides along a fine movement rail, fixed to the rough movement slider, for positioning operation in a second stroke range narrower than the first stroke range with the second positioning accuracy; and
a switching mechanism for switching between a connected condition, where the fine movement slider is mechanically connected to the rough movement slider, and an unconnected condition, where the fine movement slider is released from the rough movement slider.

3. The rough and fine movement mechanism according to claim 2,
wherein the switching mechanism includes a braking mechanism for keeping the fine movement slider connected to the rough movement slider with a predefined braking force so as to prevent the fine movement slider from relatively moving in relationship with the rough movement slider.
